(19) United States
(12) Patent Application Publication
(10) Pub. No.: US 2026/0312317 A1
(43) Pub. Date: Oct. 8, 2026

(54) CONNECTOR INCLUDING PLURALITY OF JOINTS ALIGNED IN TWO ROWS

(71) Applicant: KYOCERA Document Solutions Inc., Osaka (JP)

(72) Inventor: Minoru SHINBA, Osaka (JP)

(73) Assignee: KYOCERA Document Solutions Inc., Osaka (JP)

(21) Appl. No.: 19/636,152

(22) Filed: Apr. 1, 2026

(30) Foreign Application Priority Data
Apr. 8, 2025 (JP) 2025-063907

(51) Int. Cl. H01R 13/02; H01R 13/04; H01R 13/405; H01R 13/504

(52) U.S. Cl. CPC H01R 13/025; H01R 13/04; H01R 13/405; H01R 13/504

(57) ABSTRACT

A connector includes a plurality of groove joints, to each of which a wire is to be connected, the groove joints being aligned in two rows, parallel to each other and extending in a transverse direction x, the two rows being stacked in an up-down direction z. When one of the rows includes at least one vacant groove joint, to which the wire is not connected, and when an imaginary line is drawn so as to pass a center between the two rows and extend parallel thereto, and a position on the imaginary line, corresponding to a center of each of the rows, is defined as a center of 180 degrees rotational symmetry, the wire is not connected to the groove joint in the other row, rotationally symmetric at 180 degrees, with respect to the vacant groove joint in the first mentioned row.

### INCORPORATION BY REFERENCE

This application claims priority to Japanese Patent Application No.2025-063907 filed on Apr. 8, 2025, the entire contents of which are incorporated by reference herein.

### BACKGROUND

The present disclosure relates to a connector including a plurality of joints aligned in two rows.

Existing electrical connectors generally include an array of a plurality of wire reception recesses, each of which receives and retains a wire, and an array of a plurality of insertion holes each of which receives and retains a post terminal (terminal pin). One each of the wire reception recess and the insertion hole are located adjacent to each other to constitute a pair, and a contact crossing the wire reception recess and the insertion hole is provided in each pair, so that the wire in the wire reception recess and the post terminal in the insertion hole are connected via the contact. In addition, a two-row connector is known, in which two of the mentioned electrical connectors are stacked on each other.

### SUMMARY

The disclosure proposes further improvement of the foregoing techniques.

In an aspect, the disclosure provides a connector including a plurality of first joints, to each of which a wire is to be connected, the first joints being aligned in two rows, parallel to each other and extending in one direction, the two rows being stacked in a direction orthogonal to the one direction. In the connector, when one of the rows includes at least one vacant first joint, to which the wire is not connected, and when an imaginary line is drawn so as to pass a center between the two rows and extend parallel thereto, and a position on the imaginary line, corresponding to a center of each of the rows in the one direction, is defined as a center of 180 degrees rotational symmetry, the wire is not connected to the first joint in the other row, rotationally symmetric at 180 degrees, with respect to the vacant first joint in the one row.

### BRIEF DESCRIPTION OF THE DRAWINGS

FIG. 1 is a plan view showing a two-row connector according to an embodiment of the disclosure;

FIG. 2A and FIG. 2B are a plan view and a front view, respectively, schematically showing the two-row connector according to the embodiment;

FIG. 3 is a perspective view showing terminal pins aligned in two rows;

FIG. 4A and FIG. 4B are schematic drawings each showing another example of vacant groove joints according to the embodiment, to which a wire is not connected; and

FIG. 5A and FIG. 5B are schematic drawings each showing a comparative example of vacant groove joints, to which a wire is not connected.

### DETAILED DESCRIPTION

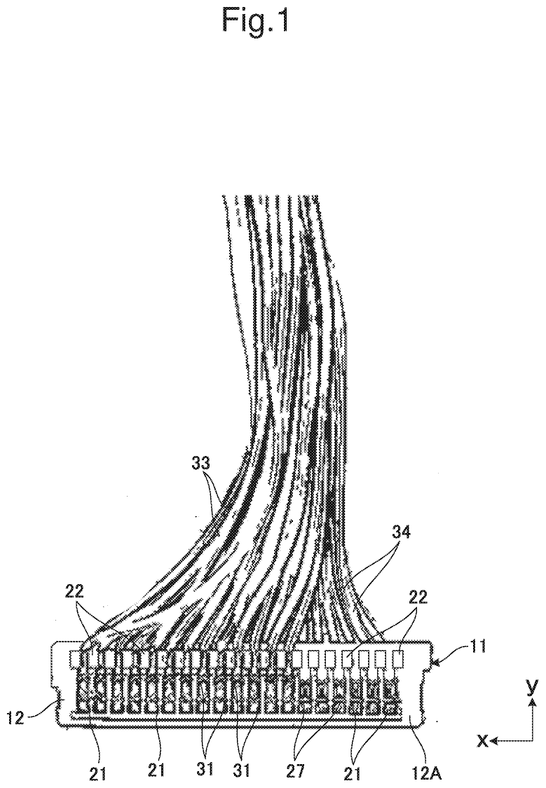

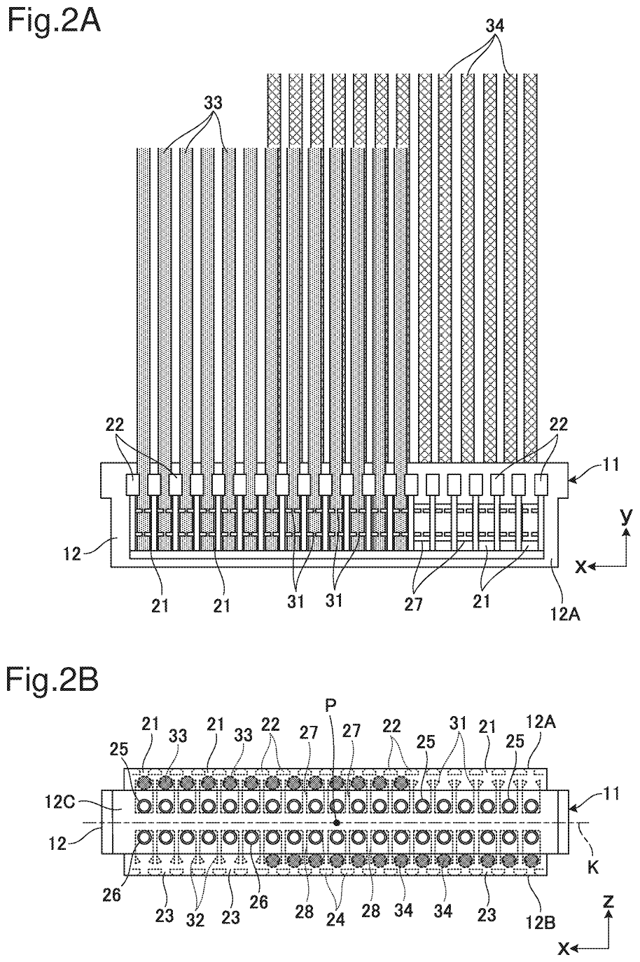

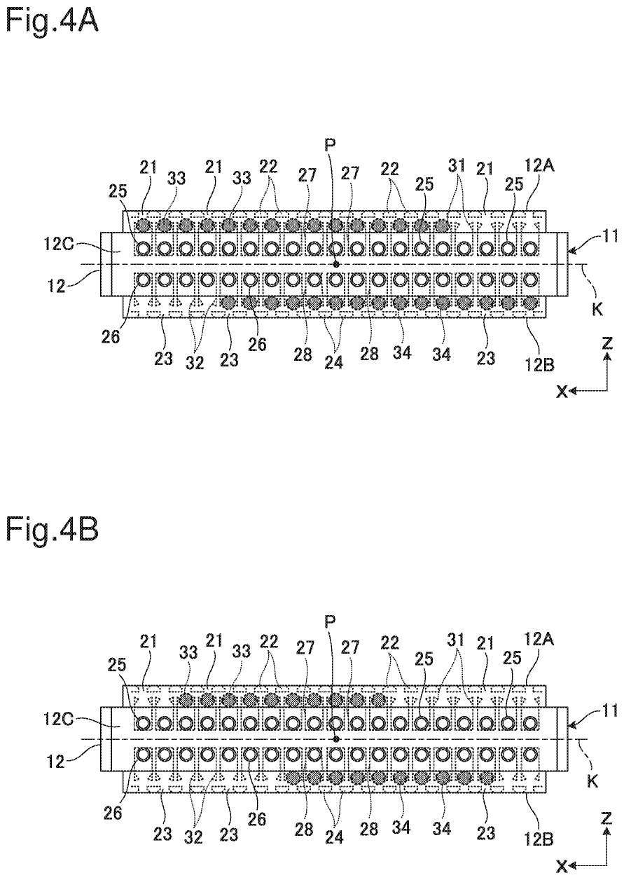

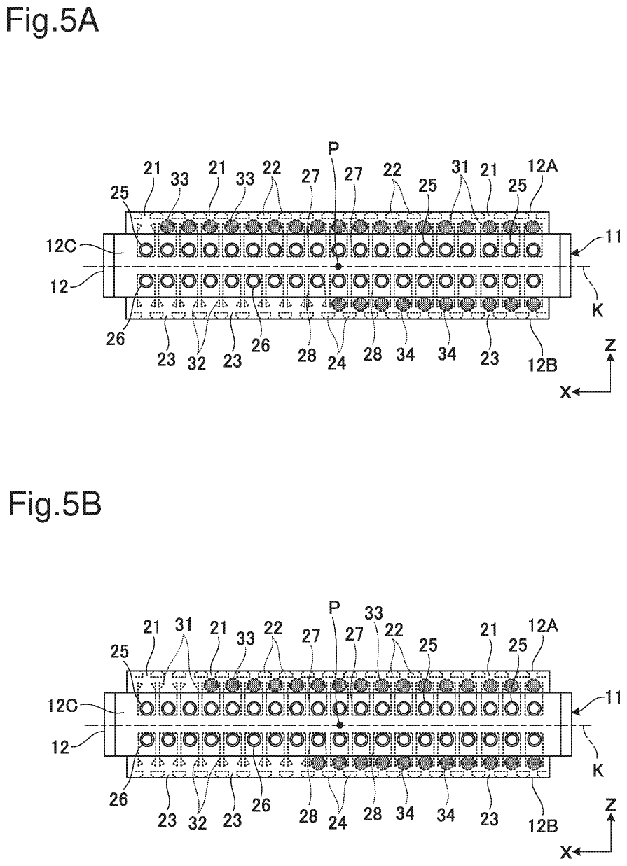

Hereafter, an embodiment of the disclosure will be described, with reference to the drawings. FIG. 1 is a plan view showing a two-row connector according to an embodiment of the disclosure. FIG. 2A is a schematic plan view showing the two-row connector according to the embodiment, and FIG. 2B is a schematic front view showing the two-row connector according to the embodiment. In FIG. 1, FIG. 2A, and FIG. 2B, and also FIG. 4A, FIG. 4B, FIG. 5A and FIG. 5B to be subsequently referred to, the transverse direction in the two-row connector 11 in FIG. 1, FIG. 2A, and FIG. 2B, exemplifying the one direction according to the disclosure, will be denoted by x, the vertical direction in FIG. 1 and FIG. 2A will be denoted by y, and an up-down direction in FIG. 2B, exemplifying the direction orthogonal to the one direction according to the disclosure, will be denoted by z.

As shown in FIG. 1, FIG. 2A, and FIG. 2B, the two-row connector 11 includes a connector main body 12 of a generally rectangular solid shape, formed by molding an insulative synthetic resin. The connector main body 12 includes one face (hereinafter, A-face) 12A and the other face (hereinafter, B-face) 12B, opposed to each other in the up-down direction z. The A-face 12A and the B-face 12B extend in the transverse direction x and the vertical direction y. The connector main body 12 also includes an end face 12C, extending in the transverse direction x and the up-down direction z.

On the A-face 12A of the connector main body 12, a plurality of groove joints 21, each extending in the vertical direction y, are aligned in the transverse direction x. Between the groove joints 21 adjacent to each other, a rib 22 is formed at an end portion of the groove joint 21, so as to protrude to the inner region of the groove joint 21. Likewise, on the B-face 12B of the connector main body 12, a plurality of groove joints 23, each extending in the vertical direction y, are aligned in the transverse direction x, and between the groove joints 23 adjacent to each other, a rib 24 is formed at an end portion of the groove joint 23, so as to protrude to the inner region of the groove joint 23. The groove joints 21 and the groove joints 23 constitute two rows, parallel to each other and stacked on each other in the up-down direction z. The groove joint 21 and the groove joint 23 correspond to the first joint according to the disclosure.

On the end face 12C of the connector main body 12, a plurality of hole joints 25, each extending in the vertical direction y, are aligned in the transverse direction x, and also a plurality of hole joints 26 each extending in the vertical direction y are aligned in the transverse direction x. The hole joints 25 and the hole joints 26 constitute, like the groove joints 21 and the groove joints 23, two rows parallel to each other, and stacked on each other in the up-down direction z. The hole joint 25 and the hole joint 26 correspond to the second joint according to the disclosure.

The groove joints 21 on the A-face 12A of the connector main body 12 are respectively located adjacent to the hole joints 25 on the end face 12C of the connector main body 12 in the up-down direction z, and one of the groove joints 21 and one of the hole joints 25 adjacent to each other constitute a pair. Likewise, the groove joints 23 on the B-face 12B of the connector main body 12 are respectively located adjacent to the hole joints 26 on the end face 12C of the connector main body 12 in the up-down direction z, and one of the groove joints 23 and one of the hole joints 26 adjacent to each other constitute a pair.

A conductive contact 27, for communication between the groove joint 21 and the hole joint 25, is provided for each of the pairs of the groove joint 21 on the A-face 12A of the connector main body 12 and the hole joint 25 on the end face 12C of the connector main body 12. Likewise, a conductive contact 28, for communication between the groove joint 23 and the hole joint 26, is provided for each of the pairs of the groove joint 23 on the B-face 12B of the connector main body 12 and the hole joint 26 on the end face 12C of the connector main body 12.

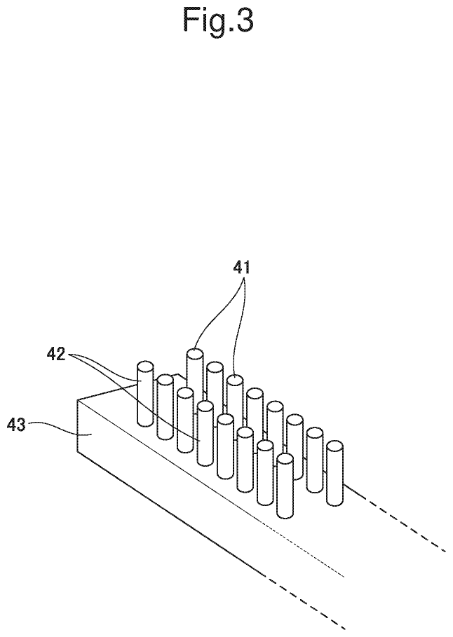

The conductive contact 27 or 28 includes a non-illustrated contact portion, located in contact with a pair of contact projections 31 or 32 protruding toward each other, to the inner region of the groove joint 21 or 23, and with a terminal pin 41 or 42 (see FIG. 3) inserted to the inside of the hole joint 25 or 26.

In each of the groove joints 21 on the A-face 12A of the connector main body 12, an end portion of a wire 33, separated into each single wire, is press-inserted and retained, and the end portions of the respective wires 33 are aligned in the transverse direction x. Likewise, in each of the groove joints 23 on the B-face 12B of the connector main body 12, an end portion of a wire 34, separated into an individual line, is press-inserted and retained, and the end portions of the respective wires 34 are aligned in the transverse direction x. The wires 33 and 34 are formed by coating a conductive core wire with an insulative synthetic resin.

The end portion of the wire 33 is press-inserted into between the ribs 22 on the respective sides of the groove joint 21, so that the end portion of the wire 33 is fitted in the groove joint 21, in each of the groove joints 21 on the A-face 12A of the connector main body 12. The end portion of the wire 33 is pressed by the ribs 22 on the respective sides of the groove joint 21, thus to be retained in the inner region of the groove joint 21. At this point, the coating of the end portion of the wire 33 is torn by being caught between the pair of contact projections 31 of the conductive contact 27, so that the conductive core wire of the wire 33 makes contact with the contact projections 31, thereby establishing the connection with the conductive contact 27. Likewise, the end portion of the wire 34 is press-inserted into between the ribs 24 on the respective sides of the groove joint 23, so that the end portion of the wire 34 is fitted in the groove joint 23, in each of the groove joints 23 on the B-face 12B of the connector main body 12. The end portion of the wire 34 is pressed by the ribs 24 on the respective sides of the groove joint 23, thus to be retained in the inner region of the groove joint 23. The coating of the end portion of the wire 34 is torn by being caught between the pair of contact projections 32 of the conductive contact 28, so that the conductive core wire of the wire 34 makes contact with the contact projections 32, thereby establishing the connection with the conductive contact 28.

The mentioned structure, that the coating of the wire is torn by being caught between the pair of contact projections of the conductive contact, so that the conductive core wire of the wire makes contact with the contact projections, thereby establishing the connection with the conductive contact, is generally known. Such structure is disclosed, for example, in JP-A-No. Sho59-42785.

Two rows of terminal pins, namely the terminal pins 41 and 42 shown in FIG. 3, are respectively inserted in the two rows of hole joints, namely the hole joints 25 and 26, on the end face 12C of the connector main body 12. The terminal pins 41 and the terminal pins 42 are each formed so as to stick out from a rectangular base plate 43, formed by molding an insulative synthetic resin. The base plate 43 is fixed to a non-illustrated printed circuit board, and the terminal pins 41 and the terminal pins 42 are connected to respective parts, via conductor patterns formed on the printed circuit board.

When the terminal pins 41 aligned in a row are respectively inserted in the hole joints 25 aligned in a row on the end face 12C of the connector main body 12, the terminal pins 41 each make contact with the contact portion of the conductive contact 27, inside the hole joint 25. Since the conductive core wire of the wire 33 is, as described above, in contact with the contact projection 31 of the conductive contact 27 in each of the groove joints 21 on the A-face 12A of the connector main body 12, the terminal pin 41 in each of the hole joints 25 is connected to the conductive core wire of the wire 33 in the groove joint 21, via the conductive contact 27. Likewise, when the terminal pins 42 aligned in a row are respectively inserted in the hole joints 26 aligned in a row on the end face 12C of the connector main body 12, the terminal pins 42 each make contact with the contact portion of the conductive contact 28, inside the hole joint 26. Since the conductive core wire of the wire 34 is, as described above, in contact with the contact projection 32 of the conductive contact 28 in each of the groove joints 23 on the B-face 12B of the connector main body 12, the terminal pin 42 in each of the hole joints 26 is connected to the conductive core wire of the wire 34 in the groove joint 23, via the conductive contact 28.

As described above, when the end portion of the wire 33 is fitted in the groove joint 21 on the A-face 12A of the connector main body 12, so that the conductive core wire of the wire 33 is connected to the conductive contact 27, and the terminal pins 41 aligned in a row are respectively inserted in the hole joints 25 aligned in a row on the end face 12C of the connector main body 12, the terminal pin 41 is connected to the conductive core wire of the wire 33 in the groove joint 21, via the conductive contact 27. Likewise, when the end portion of the wire 34 is fitted in the groove joint 23 on the B-face 12B of the connector main body 12, so that the conductive core wire of the wire 34 is connected to the conductive contact 28, and the terminal pins 42 aligned in a row are respectively inserted in the hole joints 26 aligned in a row on the end face 12C of the connector main body 12, the terminal pin 42 is connected to the conductive core wire of the wire 34 in the groove joint 23, via the conductive contact 28.

As described above, the terminal pins 41 and the terminal pins 42 are respectively connected to the parts, via the conductor patterns on the printed circuit board. Accordingly, the wires 33 and 34 are respectively connected to the conductor patterns on the printed circuit board, via the conductive contacts 27 and 28 on the two-row connector 11 and the terminal pins 41 and 42, and further to the parts via the conductor patterns.

Now, since it is not necessary to connect the wire to such parts that are not mounted on the printed circuit board, the unused wires are removed from the two-row connector 11.

However, when a plurality of wires are removed from the two-row connector 11, and the removed wires are located only on one side of the two-row connector 11, and the two-row connector 11 is to be removed from the base plate 43 fixed to the printed circuit board, by pulling the wires, the pulling force is unevenly exerted to the two-row connector 11. In such a case, it becomes difficult to remove the two-row connector 11, and the wire may be broken.

In this embodiment, therefore, the wire connection to the two-row connector 11 is arranged such that, when one of the two rows, respectively including the groove joints 21 and the groove joints 23, includes at least one vacant groove joint, to which the wire is not connected, and when an imaginary line is drawn so as to pass the center between the two rows and extend parallel thereto, and a position on the imaginary line, corresponding to the center of each of the rows in the transverse direction x, is defined as the center of 180 degrees rotational symmetry, the wire is not connected to the groove joint in the other row, rotationally symmetric at 180 degrees, with respect to the vacant groove joint in the first mentioned row.

For example, an imaginary line K, passing the center between the two rows respectively including the groove joints 21 and the groove joints 23, and extending parallel thereto, is drawn, and the position on the imaginary line K corresponding to the center P of the two rows in the transverse direction x, is defined as the center of 180 degrees rotational symmetry, as shown in FIG. 2B. When the six groove joints 21 on the right side are vacant, without the wire connected thereto, the wire is not connected to the six groove joints 23 on the left side in the lower row, which are rotationally symmetric with respect to the six groove joints 21 on the right side in the upper row, and thus the six groove joints 23 on the left side in the lower row are left vacant.

The mentioned arrangement prevents, when the two-row connector 11 is to be removed from the base plate 43 fixed to the printed circuit board, by pulling the wires 33 and 34, the pulling force from being unevenly exerted to the two-row connector 11, thereby mitigating the degree of difficulty in removing the two-row connector 11, and preventing the breaking of the wire.

FIG. 4A and FIG. 4B each illustrate another example of the wire connection status to the groove joints 21 and the groove joints 23, including the vacant groove joints to which the wire is not connected. In FIG. 4A, the center P on the imaginary line K, passing the center between the two rows respectively including the groove joints 21 and the groove joints 23 and extending parallel thereto, is defined as the center of the rotational symmetry, and four groove joints 21 on the right side in the upper row are vacant groove joints to which the wire is not connected. Therefore, the wire is not connected to four groove joints 23 on the left side in the lower row, which are rotationally symmetric with respect to the four groove joints 21 on the right side in the upper row, and thus the four groove joints 23 on the left side in the lower row are left vacant.

In FIG. 4B, seven groove joints 21 on the right side, and two groove joints 21 on the left side in the upper row are vacant groove joints to which the wire is not connected. Therefore, the wire is not connected to seven groove joints 23 on the left side, and two groove joints 23 on the right side in the lower row, which are rotationally symmetric with respect to the seven groove joints 21 on the right side, and the two groove joints 21 on the left side in the upper row, and thus the seven groove joints 23 on the left side, and two groove joints 23 on the right side in the lower row, are left vacant.

In both of the mentioned cases, when the two-row connector 11 is to be removed, the pulling force can be prevented from being unevenly exerted to the two-row connector 11, and therefore the degree of difficulty in removing the two-row connector 11 can be mitigated, and the breaking of the wire can be prevented.

FIG. 5A and FIG. 5B each illustrate a comparative example of the wire connection status to the groove joints 21 and the groove joints 23 including vacant groove joints to which the wire is not connected. In both of FIG. 5A and FIG. 5B, the vacant groove joints 21 in the upper row, and the vacant groove joints 23 in the lower row, are not rotationally symmetric with respect to each other. Therefore, when the two-row connector 11 is to be removed, the pulling force is unevenly exerted to the two-row connector 11, which makes it difficult to remove the two-row connector 11, and may break the wire.

According to this embodiment, in contrast, the center P on the imaginary line K, passing the center between the two rows respectively including the groove joints 21 and the groove joints 23 and extending parallel thereto, is defined as the center of 180 degrees rotational symmetry, and the wire is not connected to the groove joint in one of the rows, rotationally symmetric at 180 degrees, with respect to the vacant groove joint in the other row. Therefore, when the two-row connector 11 is to be removed by pulling the wires 33 and 34, the pulling force can be prevented from being unevenly exerted to the two-row connector 11. As a result, the degree of difficulty in removing the two-row connector 11 can be mitigated, and the breaking of the wire can be prevented.

The foregoing embodiment represents the case where the coating of the wires 33 and 34 is torn by being caught between the two contact projections 31 and 32 of the conductive contacts 27 and 28, so that the conductive core wire of each of the wires 33 and 34 makes contact with the contact projections 31 and 32, thus to be connected to the conductive contact 27 or 28. However, various connectors, each having a different structure for connecting the end portion of the wire to the conductive contact, are currently known, and therefore the disclosure may be applied to such connectors.

The existing image forming apparatuses are classified into a plurality of models, on the basis of difference among color printers, monochrome printers, production PPM, and so forth, but the circuit board is often designed in common to different models, despite the number of parts, such as motors and sensors, being different among the models, and the same connector is often employed in common to the different models. In this case, some parts are not used depending on the model, and since there is no need to arrange the electrical connection for the unused parts, the wire(s) for such parts, to be connected to the terminal pin on the side of the circuit board, is(are) removed from the connector. In other words, among the wires on the side of the connector, to be connected to the respective terminal pins on the side of the circuit board, the wire(s) corresponding to the unused parts is(are) removed, and the pin becomes vacant.

However, when a plurality of wires are removed on the side of the connector, and the removed wires are located only on one side of the connector, the force for removing the connector is unevenly exerted to the connector. Accordingly, it becomes difficult to remove the connector, and the wire may be broken.

In the case of the two-row connector, in particular, the number of wires and the number of terminal pins are significantly larger, and a larger force is required to remove the connector from the terminal pins. Therefore, when the removed wires are located only on one side of the connector, the degree of difficulty in removing the connector is further increased, and the wire becomes more likely to be broken.

With the arrangement according to the foregoing embodiment, in contrast, the degree of difficulty in removing the connector can be mitigated, and the breaking of the wire can be prevented, even in the case of the two-row connector.

Further, the configurations and processings described in the embodiment with reference to FIG. 1 to FIG. 5B are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. A connector comprising a plurality of first joints, to each of which a wire is to be connected, the first joints being aligned in two rows, parallel to each other and extending in one direction, the two rows being stacked in a direction orthogonal to the one direction,
wherein, when one of the rows includes at least one vacant first joint, to which the wire is not connected, and when an imaginary line is drawn so as to pass a center between the two rows and extend parallel thereto, and a position on the imaginary line, corresponding to a center of each of the rows in the one direction, is defined as a center of 180 degrees rotational symmetry, the wire is not connected to the first joint in the other row, rotationally symmetric at 180 degrees, with respect to the vacant first joint in the one row.

2. The connector according to claim 1,
wherein the number of the first joints in each of the rows is equal.

3. The connector according to claim 1, further comprising a plurality of second joints, to each of which a terminal pin is to be connected, aligned in two rows, parallel to each other and extending adjacent to the first joints in the one direction.

4. The connector according to claim 3,
wherein the first joint is formed as a groove joint in which an end portion of the wire is press-inserted and retained, and the second joint is formed as a hole joint in which the terminal pin is inserted and retained.
